(19) United States
(12) Patent Application Publication
(10) Pub. No.: US 2007/0119381 A1
(43) Pub. Date: May 31, 2007

(54) Fish tank with integrated gravity assisted cleaning apparatus

(76) Inventor: Joseph H. Chang, Kirkland, WA (US)

Correspondence Address: DEAN A. CRAINE, SUITE 140, 400 - 112TH AVE NE, BELLEVUE, WA, 98004, US

(21) Appl. No.: 11/288,801

(22) Filed: Nov. 29, 2005

(51) Int. Cl. A01K 63/04

(52) U.S. Cl. 119/264

(57) ABSTRACT

A fish tank with an integrated gravity assisted cleaning apparatus comprising a tank capable of holding a suitable volume of water with a siphon tube with a lower proximal end that extends into the tank near or at the tank's bottom surface attaches to a siphon tube connector attached to the side of the tank. The siphon tube includes a distal end that is fixed or adjustably attached at different elevated positions on the side of the tank integrally formed on the siphon tube connector or attached to the siphon tube is a manual valve. In the preferred embodiment, the distal end is located at a position at or near the desired level of the water. When fresh water is added to the tank, a volume of dirty water equal to the amount of fresh water added to the tank is discharged.

### BACKGROUND OF THE INVENTION

1. Field of the Invention

The invention relates to fish tank accessories, and more particularly to an aquarium cleaning system used with fish tanks.

2. Description of the Related Art

Maintaining aquatic life in a tank or aquarium is a common endeavor. Fish and other organisms are relatively easy to care for and in many cases only require periodic feeding. As the living environment for the fish, the tank or aquarium requires both cleaning and the frequent replacement water in the tank. In some cases, caring for the aquarium is more tedious than caring for the fish. This process can be cumbersome both for the person performing the periodic maintenance and the organisms who have their living space disrupted.

Removing water can be messy and tedious for large tanks. Spilling fish waste in a person's living space can be very disruptive and is highly undesirable. Removing the fish from the tank in order to change the water can also be dangerous for the fish and cause injury, and sometimes lead to death.

Filtration systems have been utilized to lengthen the time between required water changes in an aquarium. These systems require electricity and additional maintenance of the filter unit. They do not address the need for a simple method of changing a portion of the dirty water.

There also have been attempts to simplify the procedure for cleaning an aquarium, but these systems are costly and complicated. For example, U.S. Pat. No. 6,234,113 (Dor) discloses a segregated aquarium with a pump, valve, and filter. Cleaning of this system requires several steps including the manipulation of a valve. U.S. Pat. No. 5,240,596(Chesnut) discloses the use of a siphon, but utilizing the disclosed system requires the user to physically manipulate a cleaning apparatus in the aquarium to affect cleaning. This system also requires the operation of a valve for the system to operate, further complicating the cleaning procedure.

Improvements such as that disclosed in U.S. Pat. No. 5,690,054 (Allen) also utilize a siphon, however the disclosed apparatus requires the additional manipulation of a valve to initiate the operation of the siphon, therefore complicating the cleaning and water exchange process and further making it unsuitable for use by children.

Aquarium systems known in the art have required multiple or complex steps in order to clean the system. These systems often require the use of electricity and manipulation of valves. There is a need for an aquarium system that vastly simplifies the cleaning and water exchange procedure in an aquarium by providing an aquarium with an integrated gravity assisted cleaning apparatus with a cleaning procedure as simple as possible.

### SUMMARY OF THE INVENTION

It is an object of the present invention to provide a fish tank with a siphon port formed thereon in which a siphon tube connector is inserted. An outside siphon tube is then connected to the siphon tube connector. The siphon tube then bends upward over the outer surface of the tank so that the distal end of the siphon tube is located at or near the desire water level inside the tank. When clean water is slowly added to the tank, dirty water and the debris located on or near the bottom surface of the tank flows into the siphon port connector and into the siphon tube. The dirty water and debris then exits from the distal end of the siphon tube and is conveniently collected in a container.

An important aspect of the invention is that hydrostatic pressure automatically stops the flow of dirty water and debris from the distal end of the siphon tube when the water level drops below the distal end of the siphon tube. By adjusting the relative position of the distal end of the siphon tube with respect to the water level in the tank, the user is able to easily adjust the water level in the tank. Also, by continuously pouring clean water into the tank, the dirty water and debris that settle on or near the bottom of the tank may be flushed out and replaced with clean water while maintaining the water at a constant level.

A manual valve is provided that allows the user to selectively control the flow of water from the tank. In one embodiment, a manual valve is attached to the distal end of the siphon tube. In another embodiment, the manual valve is integrally formed on the siphon port connector thereby enabling the siphon tube to be removed from the tank.

The siphon tube extends upward on the sidewall of tank and is permanently or temporarily fixed in position at or near the desired water level. In one embodiment, at least one clip is mounted in a fixed position on the outer surface of the sidewall designed to hold the distal end of the siphon tube in an elevated position. In another embodiment, the siphon tube is attached to a multiple clip strap that is adhesively mounted on the sidewall of the tank that allows the distal end of the siphon tube to be positioned at different elevations on the tank for different water levels.

In one embodiment of the invention, the bottom surface of the tank is flat. In other embodiments, the bottom surface of the tank is sloped to assist the flow of movement of dirty water and debris towards the siphon port. In another embodiment, a conical collection element is provided that directs dirty water or debris into an inside siphon tube that connects to the siphon tube connector. In yet another embodiment, a grate is disposed over the bottom surface of the tank that supports objects and allows dirty water and debris to fall into a collection cavity located under the grate that communicates with the siphon tube.

### DESCRIPTION OF THE DRAWINGS

FIG. 1 is a front view of a cylindrical fish tank with a siphon tube attached at one end to a siphon tube connector attached to the sidewall near the lower edge of the fish tank.

FIG. 2 is a perspective view of a rectangular tank with a flat bottom and a siphon tube connected to a siphon tube connector attached to the sidewall near the bottom surface of the tank.

FIG. 3 is a front view of an embodiment of the invention showing the position of a clip affixed to the sidewall used to attach the siphon tube on the tank shown in FIG. 1.

FIG. 4 is a sectional side elevational view of the clip shown in FIG. 3.

FIG. 5 is a sectional, side elevational view of a siphon tube connector mounted on the sidewall of the tank.

FIG. 6 is a sectional, side elevational view of a siphon tube connector mounted on the sidewall of the tank with an integrally attached manual used valve to control the flow of water therethrough.

FIG. 7 is a perspective view a pair of hook and loop pad connectors used to hold a siphon tube on the sidewall of the tank.

FIG. 8 is a front elevational view of an adjustable multiple clip device attached to the sidewall of a tank that allows the distal end of the siphon tube to be adjusted at different positions.

FIG. 9 is a side elevational view of the multiple clip device shown in FIG. 8.

FIG. 10 is a cylindrical fish tank with a conical collection element located therein with an inside siphon tube that connects to the neck of the conical element and extends outward through the sidewall and upward so that the distal end of the outside siphon tube is located near or at the water level.

FIG. 11 is a perspective view of a rectangular tank with a conical collection element located centrally on the bottom surface of the tank with an inside siphon tube attached to its neck that connects to a siphon tube connector mounted on the sidewall.

FIG. 12 is a perspective view of a rectangular tank with a sloped bottom and a siphon tube attached to a siphon tube connector on the sidewall of the tank.

FIG. 13 is a perspective view of a rectangular tank with a sloped grate structure located on the bottom surface of the tank with a lower cavity located thereunder filled with marbles with an optional elevated horizontal grate located above the sloped grate structure.

FIG. 14 is a front view of the embodiment of the invention showing a globular-shaped tank, with a conical collection element located therein with a siphon tube that extends through the bottom surface of the tank and supported on a cylindrical base.

### DESCRIPTION OF THE PREFERRED EMBODIMENT(S)

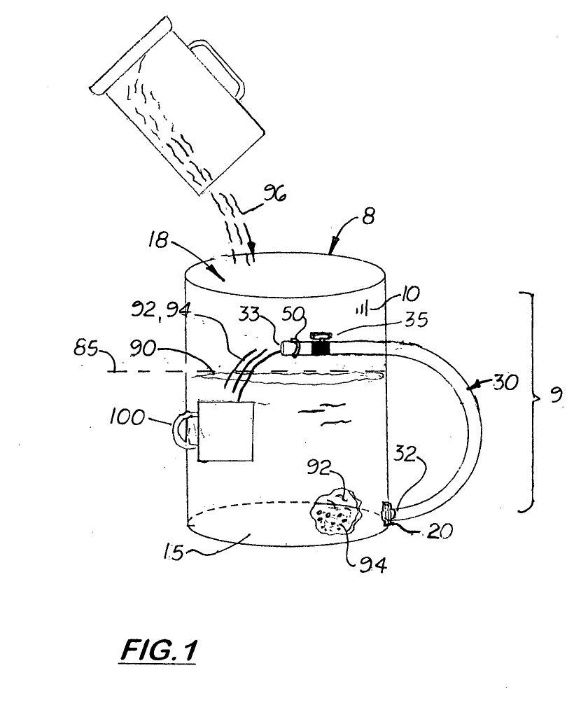

Shown in the accompanying FIGS. 1-14 and described herein is a fish tank 8 with an integrated gravity assisted cleaning apparatus, generally denoted as 9. The fish tank 8 which contains fresh or salt water 90 suitable for maintaining aquatic organisms, may be a spherical or rounded structure with one or more curved sidewalls 10 or a square or rectangular structure with three or four flat sidewalls 11-14. The sidewall 10 and 11-14 are typically made of rigid, transparent material that enables aquatic organisms living inside the tank 8 to be seen. The tank 8 also includes a flat bottom surface 15 and a top opening 18. Over time, dirty water 92 and debris 94 settle along the bottom surface 15 and must be replaced with clean water 96 and removed.

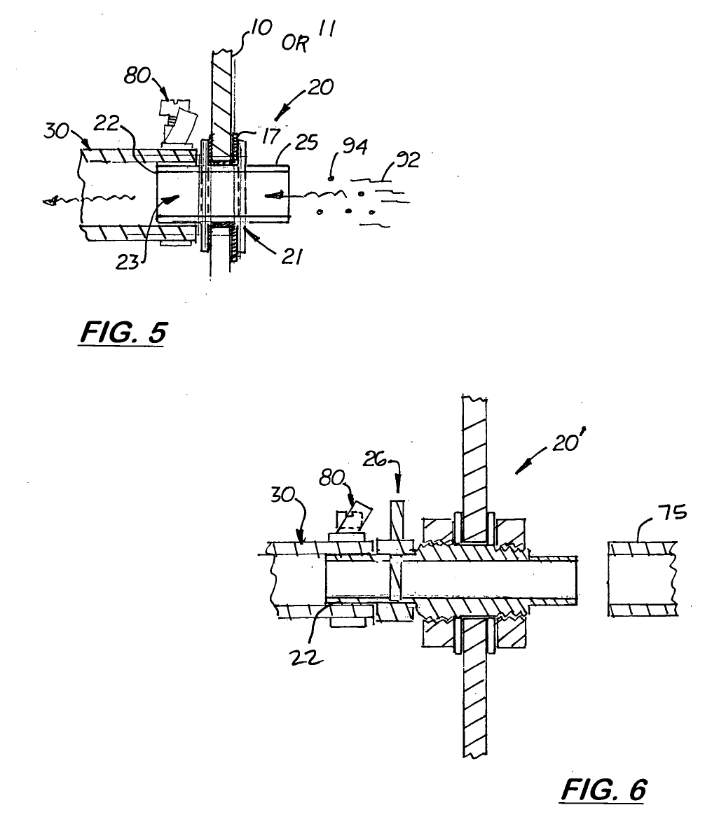

The gravity assisted cleaning apparatus 9 includes a siphon tube connector 20 formed on the sidewall 10-14 of the tank 8 near or adjacent to the bottom surface 15. The apparatus 9 also includes and a siphon tube 30 that connects to the siphon tube connector 20. In the first embodiment shown in FIG. 5, the siphon tube connector 20 includes a cylindrical body 21 that extends transversely through a bore formed in the sidewall (sidewall shown 11). The diameters of the body 21 and the bore 16 in the sidewall 11 are sufficient to create a water tight seal. An optional sealant or adhesive 17 may be used to assure a water tight seal. Formed or attached to one end of the body 21 is a longitudinal aligned neck 22. Extending through the body 21 and neck 22 is a longitudinally aligned passageway 23 which communicates with the cavity formed inside the tank 8. During assembly, the siphon tube 30 fits tightly over the neck 22. An optional clamp 80 may be used to securely hold the siphon tube 30 to the neck 22. Also shown in FIG. 5 is a second siphon tube connector, denoted 20′ that includes a second neck 25 that extends into the tank 8. As discussed further below, an inside siphon tube 75 may be attached to the second neck 25 to quickly deliver dirty water 92 and debris 94 from a conical collection element located inside the tank. FIG. 6 shows a third embodiment of the siphon tube connector, denoted 20″ that includes a manual valve 26 integrally on the first neck 22 that allows the user to selectively close the flow of water through the siphon tube 30 or allow the siphon tube 30 to connect and disconnect from the tank 8.

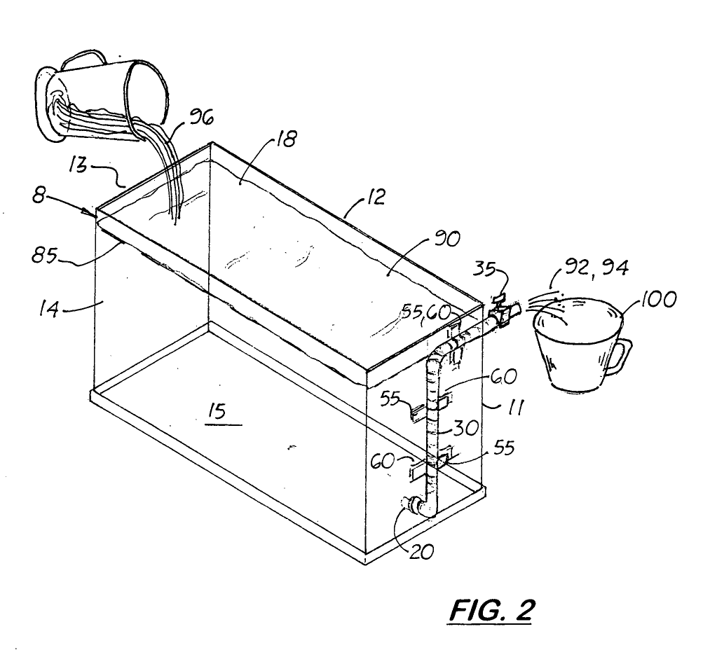

As shown in FIGS. 1 and 2, the siphon tube 30 bends upward along the outside surface of the sidewall 10. The siphon tube 30 is sufficient in length so that its distal end 33 is positioned at or near the desired water line, (designated by the reference number 85) inside the tank 8. Attached to the distal end 33 of the siphon tube 30 is a manual valve 35 which is used when the siphon tube connector 20″ that includes a manual valve 26 is not used. When new volume of clean water 96 is added to the tank 8, the manual valve 26 is opened so that an equal volume of dirty water 92 and debris 94 may flow out of the distal end 33 of the siphon tube 30 thus maintaining the water 90 inside the tank 8 at the desired water line 85. Because the proximal end 32 of the siphon tube 30 is attached to the siphon tube connector 20 at or near or at the bottom surface 15 of the tank 8, the addition of clean water 96 to the tank 8 automatically, forces the dirty water 92 and debris 94 that settles on the bottom surface 15 to flow into the siphon tube 30. A discharge bucket or container 100 is used to collect the dirty water 92 and debris 94 exiting from the distal end 15. When the task of removing debris 94 and adding clean water 96 to the tank 8 has been completed, the manual valve 35 is closed. The same procedure is used when the siphon tube connector 20″ that includes the manual valve 26 is used.

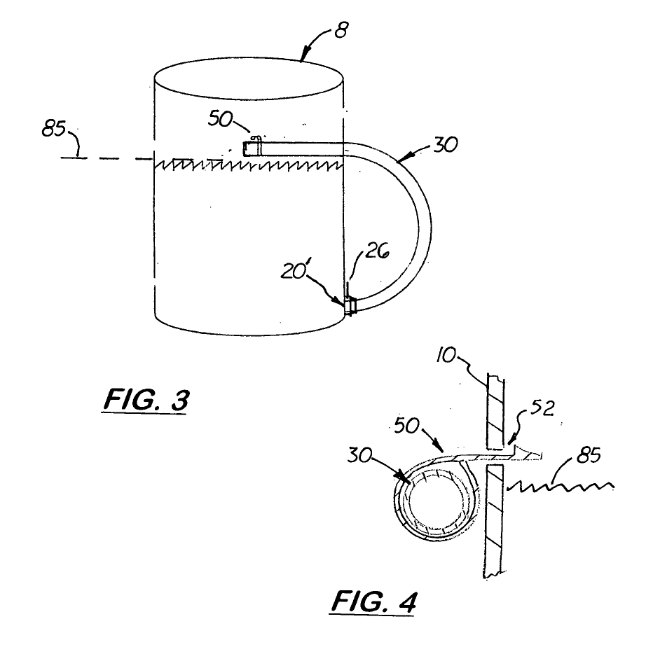

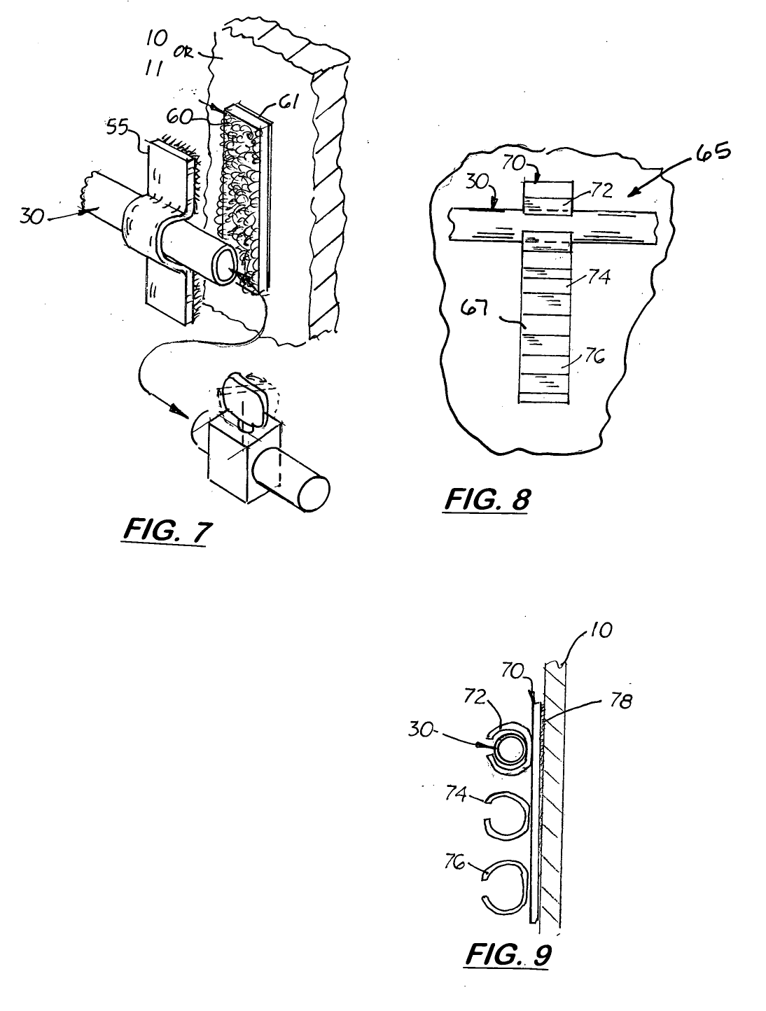

The siphon tube 30 must bend upward and held in position on the outside surface of the sidewall. As shown in FIGS. 3 and 4, in the first embodiment, a C-shaped clip 50 is used that extends around the siphon tube 30 and connects to a slot 52 formed just above the water line 85. During use, the clip 50 is extended around the siphon tube 30 and through slot 52 to hold the siphon tube 30 in an upward position on the sidewall 11. In a second embodiment, shown in FIG. 7, the C-shaped clip 50 is replaced by one or more pairs of hook and loop connector pads 55 and 60, respectively, that are selectively engaged to hold the siphon tube 30 in position on the sidewall 10. A suitable adhesive 61 may be applied to the back surface of the loop connector pad 60 it on the outside surface of the sidewall 10. The hook pad 55 is sufficient in length to extend over the siphon tube 30 and connects at its opposite ends to the loop connector pads 60.

In FIGS. 8 and 9, a third embodiment of the clip is shown (denoted 65), that includes an elongated body 67 with a plurality of C-shaped clips 69, 71, 73 mounted transversely thereon each designed to receive and hold the siphon tube 30. An adhesive layer 74 may be applied to the back of the elongated body 67 that enables to be attached it to the outside surface of the sidewall 10. When using clip 65, the user is able to easily adjust the position of the distal end 34 of the siphon tube 30 to change the water line 85 in the tank 8.

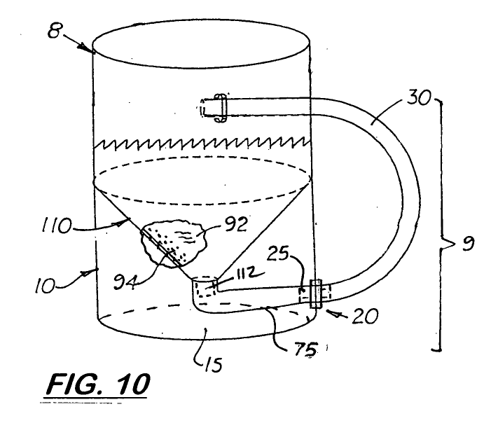

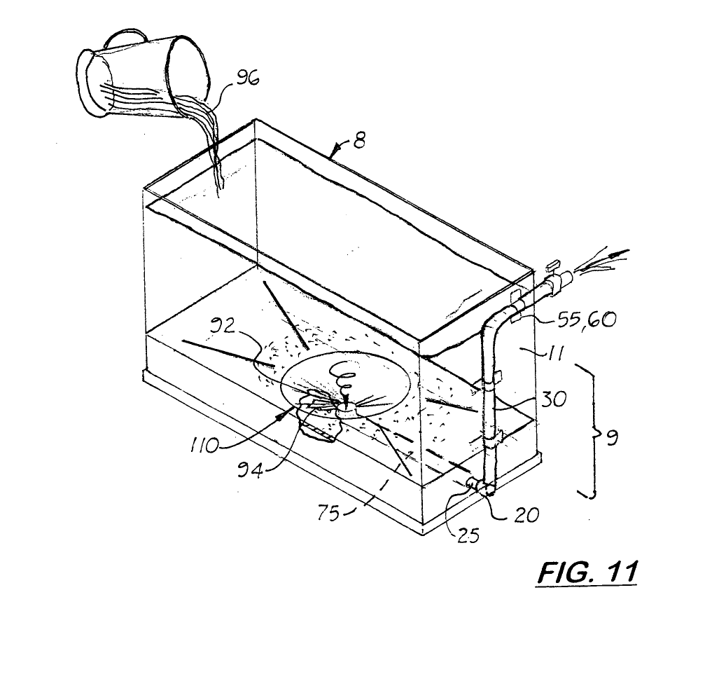

As mentioned above and as shown in FIGS. 1 and 2, in the first embodiment in the apparatus 9, the tank 8 has a flat bottom surface 15 with the siphon tube connector 20 mounted in a siphon port formed on the sidewalls 10, and 11, respectively. In another embodiment of the apparatus 9 shown in FIGS. 10 and 11, a conical collection element 110 is placed over the bottom surface 15 that is used to concentrate and collect dirty water 92 and debris 94 that settles via gravity in the tank 8. In this embodiment, the conical collection element 110 includes a lower neck 112 that attaches to an inside siphon tube 75. The inside siphon tube 75 extends laterally along the bottom surface 15 of the tank 8 and connects to the second neck 25 formed on the third embodiment of the siphon tube connector 20″ shown in FIGS. 5 and 6.

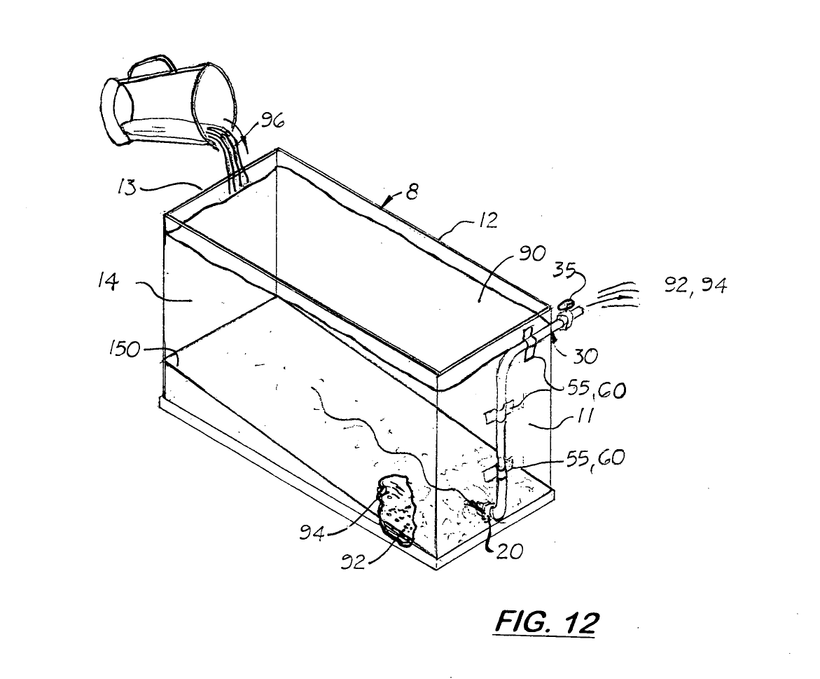

FIG. 12 shows another embodiment of the invention which uses a rectangular tank with four sidewalls 11-14, and a sloped bottom surface 150 that slants downward towards the siphon tube connector 20. When clean water 96 is added to the end of the tank 8 opposite the siphon connector tube 20, a current is created in the water 90 that forces the dirty water 92 and debris 94 settled thereon towards the siphon connector tube 20 when the manual valve 26 or 35 is opened.

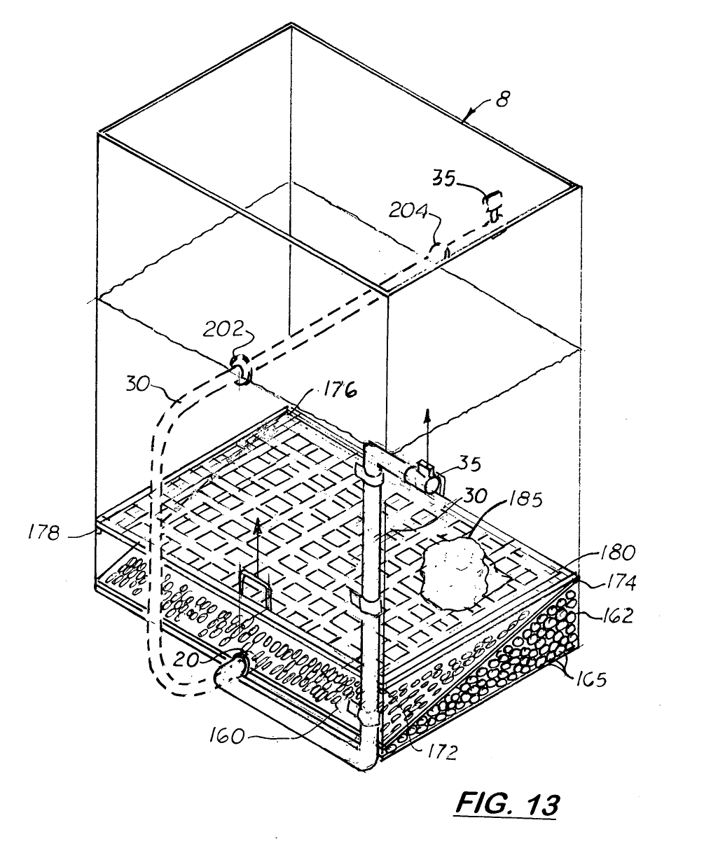

FIG. 13 shows another embodiment of the invention with a rectangular tank in which a sloped grate structure 160 placed over the bottom surface 15. Formed under the slope grated structure 160 is a lower cavity 162 in which small balls or marbles 165 may be placed. During use, the debris (not shown) collects on the marbles 165. When clean water 96 is added to the tank 8, a current is created in the water 90 along the slope grate structure 160 that washes the debris (not shown) away from the marbles 165 into the siphon tube connector 20 and into the siphon tube 30 when valve 26 or 35 is opened. Mounted on the inside surface of the tank 8 are four optional catch pins 172-178 that support an optional, horizontally aligned grate 180 in an elevated position inside the tank 8. The grate 180 is elevated and horizontally aligned above the slope grated structure 160 so that rocks 185 and other items located inside the tank are not sucked into or pulled towards the siphon tube 30.

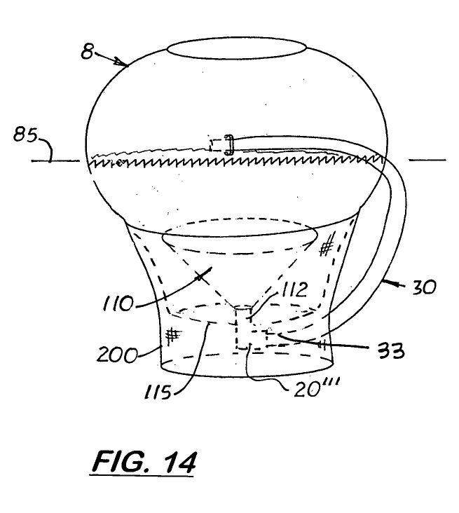

FIG. 14 illustrates another embodiment of the invention similar to the embodiments shown in FIGS. 3 and 4 that is designed to be more aesthetically pleasing. In this embodiment, the tank 8 is globular with a flat bottom surface 115. Located inside the tank 8 is a conical collection element 110 with a lower neck 112. Mounted on the bottom surface 115 of the tank 8 is an L-shaped siphon tube connector 20″ to which a siphon tube 30 attaches. The distal end 33 of the siphon tube 30 is positioned at or near the water line 85. Disposed around the tank 8 is a cylindrical base 200 made of opaque material that may be placed on the bottom surface 15 of the tank 8 to reduce visibility of the accumulated dirty water 92 or debris 94 in the bottom surface 115 of the tank 8.

In the preferred embodiments, the siphon tube connector 20 is mounted on the end surface of the tank 8. As shown in FIG. 13, the siphon tube connector 20 may be mounted in the front or rear surface of the tank 8. In the preferred embodiment, the siphon tube 30 extends laterally to the edge of the tank 8 and then upward. The siphon tube 30 then bends laterally at the water line. In an alternative embodiment, the siphon tube 30 extends outward and perpendicular from the tank 8 and then upward. The siphon tube 30 then bends inward and into a second port connector 202 located at or near the water line. The siphon tube 30 then extends across the tank 8 and through a third port connector 204 located directly across the tank 8 from the second port connector 202. A manual valve 35 is attached to the distal end of the siphon tube 30 to control the flow of water therethrough.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A gravity assisted cleaning aquarium system, comprising:
a. a tank capable of holding water at a desired liquid level, said tank including a bottom surface and an adjacent side wall, said tank also including a lower port;
b. a siphon port located on said sidewall near said bottom surface of said tank;
c. a siphon tube connector disposed inside said siphon port enabling water to flow out of the said tank;
d. a siphon tube having a proximal end and a distal end, said proximal end being attached to said siphon tube connector, said siphon tube extending upward along said sidewall of said tank so that said distal end is positioned near or at a desired water level; and,
e. a manual valve used to control the flow of water from said tank through said siphon tube so that when clean water is added to said tank, the water level inside said tank is maintained.

2. An aquarium system as claimed in claim 1, further including a means for holding said distal end of said siphon tube in an elevated location near or at the desired water level.

3. The aquarium system, as recited in claim 2, wherein said tank is rectangular.

4. The aquarium system, as recited in claim 3, wherein said tank includes a sloped bottom surface and said siphon tube connector is formed on the lower end of said sloped bottom surface.

5. The aquarium system, as recited in claim 4, further included a removable grate located in an elevated position above said sloped bottom surface.

6. The aquarium system, as recited in claim 2, further include a sloped grate located inside said tank, said sloped grate forming a lower cavity filled with marbles, said slope grate surface also being aligned inside said tank so that said siphon tube connector is located adjacent to the lower edge of said grate.

7. An aquarium system, as claimed in claim 1, wherein said manual valve is integrally formed on said siphon tube connector.

8. The aquarium system, as recited in claim 7, wherein said tank includes a sloped bottom surface and said siphon port connector is located at the lower end of said bottom surface.

9. The aquarium system, as recited in claim 1, wherein manual valve is attached to said distal end of said siphon tube.

10. The aquarium system, as recited in claim 9, further including a removable grate located in an elevated position above said bottom surface of said tank and above said siphon port connector.

11. The aquarium system, as recited in claim 9, further including a sloped grate located inside said tank with a lower cavity filled with marbles, said slope grate surface being aligned inside said tank so that said lower port is located adjacent to the lower edge of said grate.

12. An aquarium system as claimed in claim 7, further including at least one clip attached to said tank at a position approximately equal to said desired water level, said clip being suited to receive said flexible tubular siphon.

13. An aquarium system as claimed in claim 7, wherein said distal end of said siphon tube is removably attached to said sidewall of said tank by a pair of hook and loop pads.

14. An aquarium system having a gravity assisted cleaning apparatus comprising:
a. a tank capable of holding water at a desired water level and having a conical collection element located therein; and,
b. a siphon tube that extends through said tank and connects to said conical collection element; and,
c. a tank base portion having a diameter substantially similar to said tank diameter capable of supporting said tank.

15. An aquarium system as claimed in claim 14, wherein said distal end of said siphon tube bends upward and securely fixed to said tank.

16. An aquarium system as claimed in claim 15, further including a manual valve attached to said siphon tube.

17. An aquarium system as claimed in claim 16, further including a clip attached to said tank at a position approximately equal to said desired liquid level, said clip being suited to receive said siphon tube.

18. An aquarium system as claimed in claim 17, wherein said distal end of said siphon tube is removably attached to said tank by a pair of interconnected hook and loop pads.

19. An aquarium system as claimed in claim 14, wherein said tank is reasonably transparent and said tank base is at least somewhat opaque.

20. A method for cleaning the water in an aquarium, comprising the following steps:
a. selecting a tank capable of holding a liquid at a desired liquid level and having at least one side wall and a tank bottom, said tank including a siphon tube mounted thereon with a lower end located along the bottom surface of said tank and an upper end located at the desired water level on said tank;
b. filling the tank with a volume of water until the desired liquid level is reached;
c. monitoring the debris build up on the water inside the tank; and,
d. slowly adding new water to said tank when debris build up reaches an undesirable amount, sufficient amount of water being added until a desired amount of debris settled on the bottom surface of said tank is delivered to said siphon tube.
